(19) United States
(12) Patent Application Publication
(10) Pub. No.: US 2013/0275224 A1
(43) Pub. Date: Oct. 17, 2013

(54) Method and Apparatus for Advertisement Message Coordination

(71) Applicants: Kwaku O. Prakah-Asante, Commerce Township, MI (US); Perry Robinson MacNeille, Lathrup Village, MI (US); Gary Steven Strumolo, Beverly Hills, MI (US)

(72) Inventors: Kwaku O. Prakah-Asante, Commerce Township, MI (US); Perry Robinson MacNeille, Lathrup Village, MI (US); Gary Steven Strumolo, Beverly Hills, MI (US)

(73) Assignee: FORD GLOBAL TECHNOLOGIES, LLC, Dearborn, MI (US)

(21) Appl. No.: 13/444,248

(22) Filed: Apr. 11, 2012

(51) Int. Cl. G06Q 30/02

(52) U.S. Cl. 705/14.63; 705/14.62

(57) ABSTRACT

An advertisement message system includes a plurality of modules providing current state values, including at least a GPS location proximity value, a workload value, and an advertisement optimization value. The system also includes a processor configured to receive state values from the plurality of modules. The system further includes an advertisement database including a plurality of advertisements. The processor is configured to determine that ad delivery is appropriate and to select an ad with a likelihood of driver response above a certain threshold. The selection is based at least in part on a currently received GPS location proximity value, workload value and advertisement optimization value, and to deliver the advertisement through a vehicle output.

### TECHNICAL FIELD

The illustrative embodiments generally relate to a method and apparatus for advertisement message coordination.

### BACKGROUND

Drivers are provided connected services information within a vehicle cabin for convenient and efficient driving experiences. In 2010, spending on advertising was estimated at more than $300 billion in the United States. Real-time advertisements provided to drivers can have the added advantage of providing advertisements to drivers as the drivers approach a business or shopping opportunity.

Several current ideas about the provision of real time driver advertisements include:

U.S. Patent Application Publication Number 2006/0241859, which discusses a single repository for capturing, connecting, sharing, and visualizing information based on a geographic location, for example. The application discusses a schema, repository, index, and APIs for any information, place, entity, attribute, service or person that can be referenced geographically. The application also discusses a system to provide real time image data includes an input component that receives image data associated with a specific geographic area, a splitter component that splits the image data into at least two quadrants, and a storage component that stores at least a portion of the at least two quadrants. Further, the application discuses provision of on-line or real-time advertising based on a user's mapped location and/or a user preference.

U.S. Patent Application Publication Number 2008/0133323, which discusses a method for generating revenue stream by providing an advertisement (ad) to a targeted populated geographical region (PGR), wherein an ad is placed on a mobile carrier. The method comprises: (A) selecting the PGR; (B) selecting a route; (C) selecting an ad; (D) selecting a mobile carrier of the selected ad; (E) targeting the PGR by using the selected carrier of the selected ad; wherein the selected carrier of the ad follows the selected route; and (F) estimating revenue stream originated from the targeted PGR and caused by exposure to the selected ad.

U.S. Patent Application Publication Number 2008/0027799, which discusses receipt of a first request for information that is related to a specified location. A first query for advertisements related to the specified location is submitted. A response to the first query that includes one or more advertisements related to the specified location is received. At least one of the one or more advertisements related to the specified location is sent to a client device. A second query for the information based on the first request is submitted. A first search result that is responsive to the second query is received. Information that is related to the location based on the first search result is sent to the client device after sending at least one of the one or more advertisements to the client device.

U.S. Patent Application Publication Number 2004/0192351, which discusses context-relevant proximity-driven mobile advertising being accomplished by displaying advertisement content at display devices associated with mobile vehicles based on the context of the vehicles, such as location and time. An advertising context module associates plural advertisement contents with selected contexts. An advertising display controller associated with each vehicle uses a location provided by a locator device, such as a GPS locator, to determine a vehicle context and applies the context to select advertisement content for display at the vehicle.

### SUMMARY

In a first illustrative embodiment, an advertisement message system includes a plurality of modules providing current vehicle sensor state values, including at least a GPS location proximity value, a workload value, and an advertisement optimization value. The system also includes a processor configured to receive state values from the plurality of modules. The system further includes an advertisement database including a plurality of advertisements.

The processor is configured to determine that ad delivery is appropriate and to select an ad with a likelihood of driver response above a certain threshold. The selection is based at least in part on a currently received GPS location proximity value, workload value and advertisement optimization value, and to deliver the advertisement through a vehicle output.

In a second illustrative embodiment, a computer-implemented method includes receiving at least a proximity value, a workload value, and an advertisement optimization value at an advertisement processing system. The method further includes examining a plurality of advertisements until an advertisement having a delivery value above a threshold value is selected, the delivery value based at least in part on a calculation made using the received proximity value, workload value, and advertisement optimization value. The method also includes delivering the selected advertisement to a driver.

In a third illustrative embodiment, a computer readable storage medium stores instructions that, when executed by a processor cause the processor to perform the method including receiving at least a proximity value, a workload value, and an advertisement optimization value at an advertisement processing system. The method performed by the processor also includes examining a plurality of advertisements until an advertisement having a delivery value above a threshold value is selected, the delivery value based at least in part on a calculation made using the received proximity value, workload value, and advertisement optimization value. The method performed by the processor further includes delivering the selected advertisement to a driver.

### BRIEF DESCRIPTION OF THE DRAWINGS

FIG. 1 shows an illustrative vehicle computing system;

FIG. 2 shows an illustrative example of a driver advertisement message coordination system;

FIG. 3A shows an illustrative example of an advertisement status for varying driver workloads;

FIGS. 3B and 3B show illustrative examples of advertisement statuses for varying proximities and workload indicies and fixed ad values;

FIGS. 4A and 4B show illustrative examples of advertisement statuses for varying ad values and workload indices and fixed proximities;

FIG. 5 shows an illustrative example of advertisement statuses for varying proximity and ad value indices and fixed workloads;

FIG. 6 shows an illustrative example of an advertisement selection process; and

FIG. 7 shows an illustrative example of an advertisement queuing process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

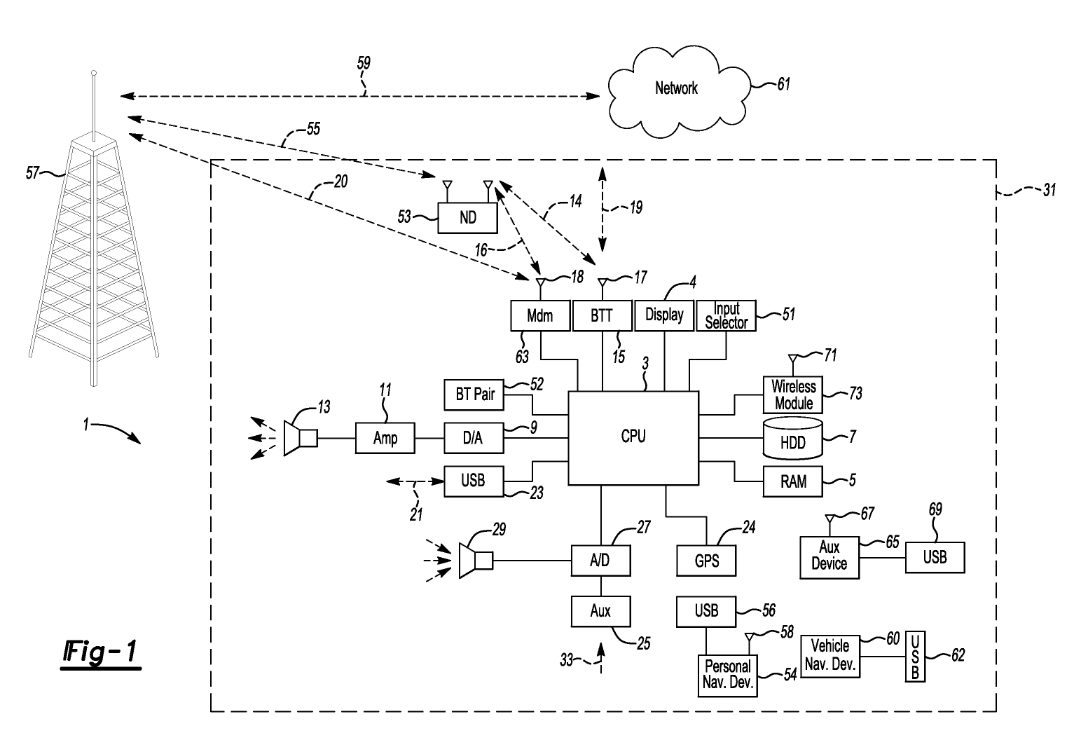

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a Bluetooth Secure Simple Pairing or similar method. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network (IEEE 802.16, IEEE 802.16.1).

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

While it may be generally known to provide advertisements to a user in a particular locale, the dynamic conditions associated with driving might require timely coordination and presentation of an advertisement message to avoid potential driver inattention/distraction. Knowledge of a driver workload can assist in ensuring the driver is either not dangerously distracted and/or has sufficient “free” faculty to actually pay attention to an advertisement. Further, knowing the value of an advertisement to a driver and knowing the proximity of a business to which the advertisement applies may also impact the effectiveness of a particular advertisement delivery.

In order to improve existing advertisement delivery systems, a driver advertisement message coordination (DAMC) system is proposed. The DAMC system provides enhanced timely delivery of ads at appropriate situations based on, for example, without limitation, driving demands and driver workload, value of advertisements to a given driver, proximity to a given good/service provider, etc.

Elements of an exemplary DAMC system include, but are not limited to: advertisement message value, proximity to location, workload/driving-demand, advertisement length selection, and acceptability of an advertisement. The resulting DAMC system is capable of providing a driver with an advertisement tailored both in relation to a location and effectiveness to a given driver, including the length of an advertisement, a higher likelihood of driver attention directed to an advertisement, and increased likelihood of driver response to an advertisement.

The DAMC system may also be capable of tracking the acceptability of an advertisement to a given driver/passenger and incorporating this data into future advertisement delivery decisions. For example, a generalized paradigm may initially be used that assumes that a short advertisement may be most effective when a driver is very close to a service provider, since the advertisement may need to be delivered quickly to effectively be noticed and utilized. But for a given driver, it may be discovered that a medium length advertisement is more effective, even at close proximity, and thus the decision tree for that driver may dynamically change.

Also, this may be a learning system in which features of the ad such as length, loudness, tempo, speech rate, use of voice, etc. are compared statistically with the level of positive feedback the driver provides. Features of advertisements that result in the driver requesting a coupon, purchasing a product, asking for information, etc. for a particular driver and work load level may have their rank increased in the driver's preference vector.

The statistical significance of the data feature preferences may depend on the number of samples used. If the significance is low then the data set may be expanded to include people considered to be similar to the driver.

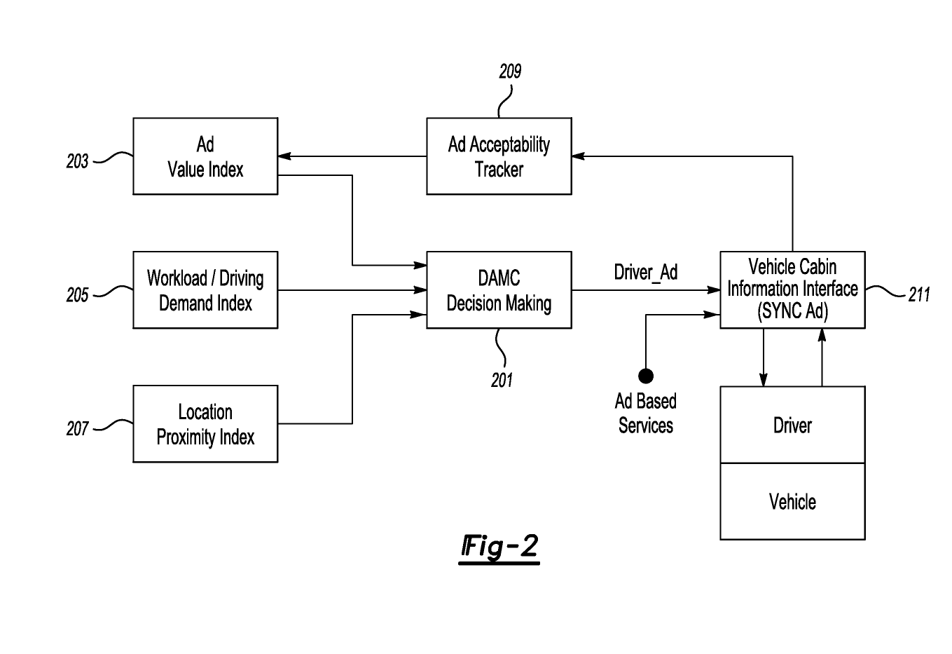

An illustrative DAMC is designed to provide an advertisement message to a driver at an appropriate time and situation to minimize the potential for driver distraction, while providing tailored communication based on, for example, an advertisement value and a proximity to a product purchase or service purchase location. FIG. 2 shows an illustrative example of such a driver advertisement message coordination system.

In the illustrative example shown in FIG. 2, a DAMC decision making process 201 has a number of possible inputs. In this example, the inputs are an advertisement value index 203, a workload index 205 and a location proximity index 207. These are exemplary inputs, and the illustrative embodiments are described with respect to these inputs, but additional and/or other suitable inputs are also possible to achieve the desired results.

An advertisement value index (which may be, for example, the value of the advertisement to the driver, the advertiser and the merchant, or any number of these or other appropriate entities) in this example, determines the value of an advertisement to one or more entities. It can be updated, and can have values based on, for example, observed behavior, group behavior, preferences of other drivers with similar behavior, vehicle context, environmental conditions, vehicle states, times of day, etc. In other words, the same advertisement may have differing values for a driver based on variables, and these values may shift over time. In one embodiment, it may be desirable to find advertisements with high value to all three entities.

A workload index can be used to measure the driving-demand/workload on a driver. This can be affected by things such as, but not limited to, weather conditions, traffic flow, times of day, number of vehicle occupants, noise levels in a vehicle, driving conditions, etc.

A location proximity index can be used to measure the proximity of a driver/vehicle to a provider of a good/service offered in an advertisement.

Once the relevant input has been received, the DAMC can process the input to determine one or more advertisements suitable for delivery to a driver. The advertisement may not only relate to a specific item/service, but the DAMC may also determine a duration of an advertisement (e.g., without limitation, short, medium, long, etc.). The vehicle cabin information interface 211 is an output (or outputs) used to present an advertisement to a driver, and can include displays, speakers, etc. An ad acceptability tracker can determine the suitability/acceptability of an advertisement to a driver, based on whether, for example, further information or a coupon is requested, or if a driver travels to an advertised merchant (based on GPS signals).

In this illustrative example, the DAMC includes a decision system exemplified for illustrative purposes only using the equations shown below:

$$Driver\_Ad = \{ \begin{matrix}1 if \{ ( Driver\_Ad \_Stat \leq {β}_{thres} ) \\ 2 if \{ ( {β}_{thres} < Driver\_Ad \_Stat \leq {δ}_{thres} ) \\ 3 if \{ ( Driver\_Ad \_Stat > {δ}_{thres} )\end{matrix}$$

Where:

Driver_Ad_Stat=Advertisement message status index from a decision system

Betaₜₕᵣₑₛ=A normal advertisement message threshold (e.g., without limitation 0.35)

Deltaₜₕᵣₑₛ=A no-advertisement message threshold (e.g., without limitation 0.68)

Driver_Ad=1, 2, 3 (1—Normal duration, 2—Short duration, 3—No advertisement)

One exemplary, usable, non-limiting general “rule” for a decision making module can take the form: {If Ad_Value is Xᵢ and WLE_Index is Yᵢ and Location_Proximity is Zᵢ then Driver_Ad_Stat is Mᵢ}

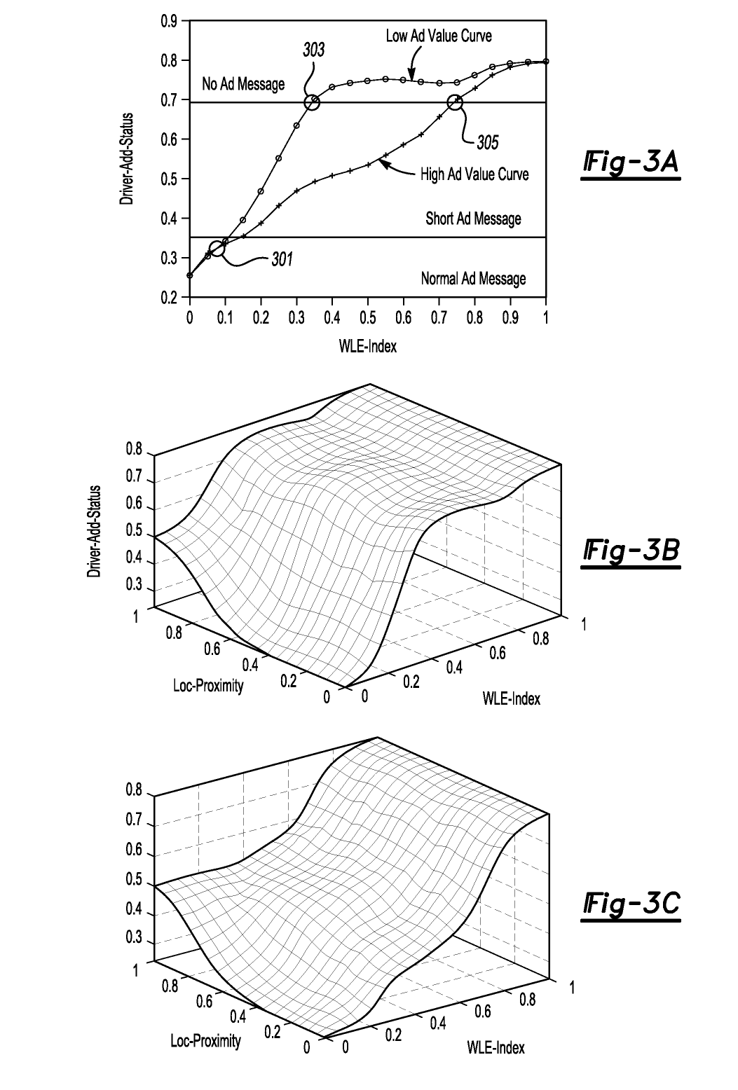

The Ad_Value, WLE_Index, and Location_Proximity Index can be scaled values ranging from 0 to 1, as can a Driver_Ad_Stat output. Input and output space may be characterized by fuzzy membership functions. An Ad_Value, WLE_Index, and Location_Proximit membership function μ may be represented by the Gaussian function:

$$μ = {e}^{( - 0.5 \frac{{( v - c )}^{2}}{{a}^{2}} )}$$

Where c represents the center of the membership function and a the width. FIGS. 3B and 3C show results of a rule-based DAMC decision output response plot showing magnitude values of a Driver_Ad_Stat for various Location_Proximities and a WLE_Index. Location_Proximity numbers closer to 0.0 represent situations where a vehicle is relatively further away from a merchant (in time or distance), where numbers closer to 1 represent situations where a vehicle is closer to a merchant. Relatively lower workload are represented by WLE_Index values closer to 0.0 and higher load values are represented by values closer to 1.

For example, without limitation, in the figure shown, when a location proximity is low (0.2) and a WLE_Index is low (0.25) and an Ad_Value is low (0.1 the constant in FIG. 3B) a Driver_Ad_Stat is less than 0.35. In this example, in such situations, Driver_Ad=1 and a normal length ad may be presented to a driver. If an Ad_Value is higher (0.7 in FIG. 3C) a balance may be struck between a location_proximity and a WLE_Index. Short duration ads (Driver_Ad=2) may be provided for a WLE_Index between 0.4 and 0.7.

FIG. 3A shows an illustrative example of an advertisement status for varying driver workloads, with a fixed medium proximity to a location (0.6 in this example). A high Ad_Value (0.7) curve and a low Ad_Value (0.1) curve are shown. It can be seen in this example, that for low workloads, in this scenario, normal advertisement messages are presented regardless of Ad_Value. As a workload increases, ads of low value shift into a “no advertisement” state much faster 303, than ads of higher value 305. This avoids potentially distracting an already busy driver with a less meaningful advertisement.

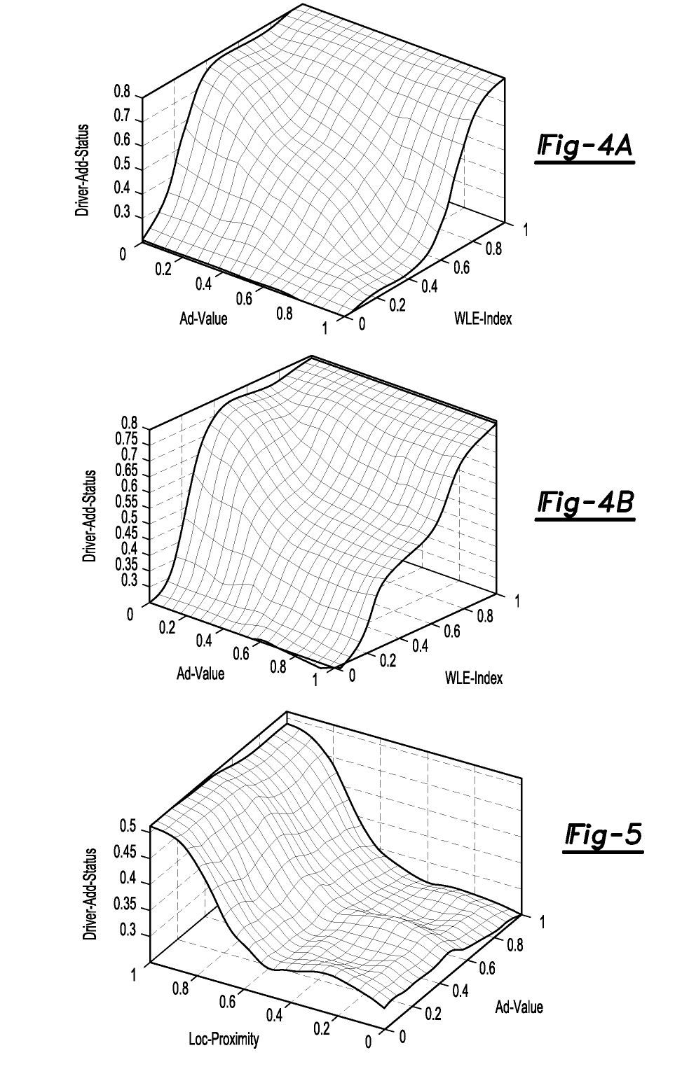

FIGS. 4A and 4B show illustrative examples of advertisement statuses for varying ad values and workload indices and fixed proximities. In these examples, results from a decision making process depict Driver_Ad_Stat output based on Ad value, WLE_Index and a fixed location proximity (4A, low proximity 0.1; 4B, medium proximity 0.5).

FIG. 5 shows an illustrative example of advertisement statuses for varying proximity and ad value indicies and fixed workload. In this example, normal duration advertisements are generally provided for low workloads unless a driver is close to a merchant destination. As a driver approaches a destination, short duration ads may be provided to allow for the driver to quickly hear an ad, for example, and react to the ad before a destination is passed.

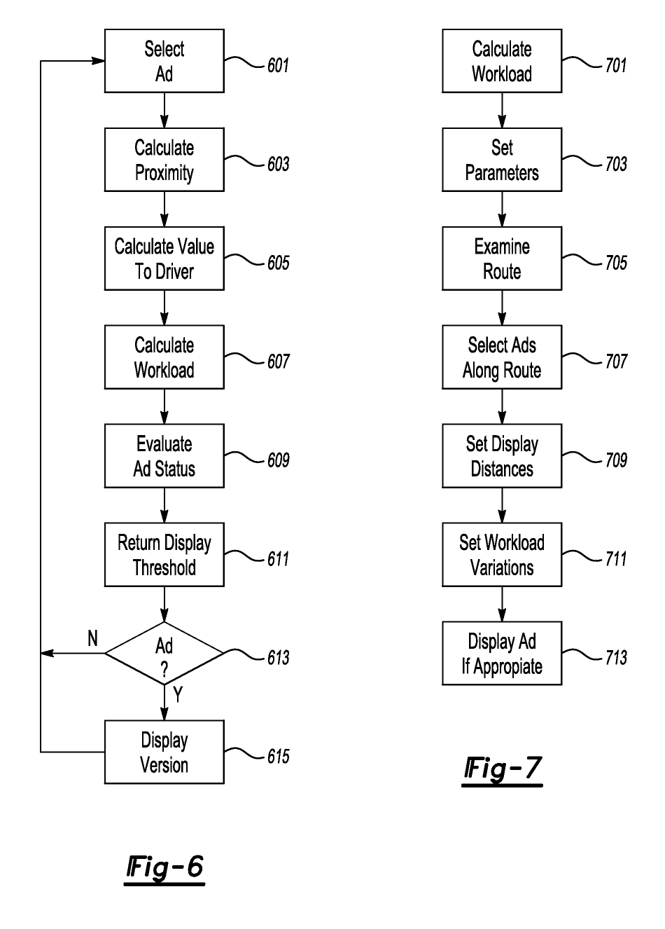

FIG. 6 shows an illustrative example of an advertisement selection process. In this illustrative example, a number of advertisements may be suitable for presentation based on, for example, value to a driver. Additionally or alternatively, merchants may pay to have ads preferentially considered. A given advertisement is selected 601 and then a number of steps are performed with respect to the advertisement.

In this process, a proximity to a merchant can be determined based on, for example, a merchant location and a current driver location. A current proximity value can be obtained 603, as well as points along a route where a proximity value may vary. Since a route is known, GPS locations where a proximity shifts may be “assigned” to an ad.

Also, an advertisement value to a driver may be known 605. This can be determined based on previously observed driver responses to an ad. Although this value may be fixed, at least until it is known if the driver reacts to an ad, this value may also vary based on, for example, context, such as, but not limited to, time of day, weather, etc. Suitable shifts in this value can also be assigned to an ad. Further, a current driver workload can be determined 607. As shown above, this workload can vary over time, and can shift dynamically throughout a drive.

Once these inputs are obtained, functions for various advertisement statuses can be known, not only for a present time/location/value/workload, but also for variances in each of the variables. Ad statuses based on variances can be calculated and assigned to the ad as well 609. Display/output threshold values for the various variables can be determined from the function, and returned or assigned to a particular ad 611.

In one non-limiting example, this process can be used to set thresholds for ads in advance along a known route, so that ad queueing can occur. For example, a driver may be starting a route and an ad for McDonalds may be observed. The time may be 4:30 pm, so the ad value may be medium, representing that a driver occasionally eats at McDonalds at this time, and so may be interested in an ad under the right conditions. A current proximity to McDonalds may be far (0.0), and while a workload is low, the proximity and value may dictate that there are better ads to be shown. In examining the route, however, it may be noted that a driver will pass close to McDonalds, and that the ad value increases as 5:00 approaches. So for a point along a route, for example, where a proximity reaches (0.5), a short or long version of the ad may be appropriate. A rising ad value as a time approaches 5:00 may dictate that the ad is more likely useful even if the proximity is farther 0.3, for example.

Using such a system, ads can even be scored against each other, so that a “most useful” ad can be shown when an ad event occurs (such as a pre-planned break in music, for example). Or, ad event timing can be planned based on the convergence of variables, so that ads are delivered at “optimal” times/locations along a route. If, for example, ten ads were to be delivered along a 30 minute route, it may be useful to ensure that the ads are delivered at the times that their values are most meaningful. Shifting values of variables along a route may shift the order of ads to be delivered, but this concept can be used to strategize advertisement delivery to a driver.

At some point along a route, an ad may be appropriate 613. Either, for example, an ad reaches a threshold determination of delivery conditions, or, for example, it is time to display an ad and a most reasonable ad is selected. The appropriate ad is then delivered to a driver 615. A weighing/evaluating process can be ongoing as a route progresses, so that ads can be queued for delivery in advance of a time when an ad is needed.

FIG. 7 shows an illustrative example of an advertisement queuing process. In this illustrative example, a driver workload is calculated 701 and parameters for various advertisements (such as shown in FIG. 6) may be set 703. A known route can be examined 705 and using the location information along a route, ads relative to the current route can be selected for delivery 707. For example, thirty ads may be possible for delivery at the onset of the process. But, once a route is examined, it is noticed that only eleven of the ads have proximities greater than 0.0 for the selected route. These ads may then be more reasonable for delivery to a driver, having a greater likelihood of the driver detouring to the selected location.

Through observation of driver behavior, it may be noticed that a proximity of, for example, 0.1 has different meanings for different drivers. For example, driver A may rarely detour more than one mile from a route, so everything over a mile off-route can be given a low or 0.0 proximity. Meaning that the driver is unlikely to travel off-route to the destination. Driver B, on the other hand, may be observed to frequently travel as far as four miles off-route, so for this driver, 0.0 does not occur until some point outside of a four mile off-route area.

Additionally, some ads may never be “on route,” and/or may relate to goods (such as, for example, an automobile) that are not daily purchases. These ads may also be worked into the “rotation”, but their proximities could be based on, for example, a proximity to known common parking locations, such as a home or work, as opposed to current route proximities. Since a driver is likely to purchase a new vehicle no sooner than every few years, it may be more useful to focus on ads that will be relevant when the decision is made. Again, these situations can also be context based. In the vehicle example, it may be known that a lease is about to expire or a vehicle has passed a certain mileage threshold. In such a case, the context of when to deliver new vehicle ads may shift so that dealerships along routes are shown, because the driver may be more likely to stop at a dealership.

Other contextual situational shifts may also be determinable based on observed behavior and statistical human behavior. Based on a given situation, variables that dictate when to display a given ad may change, and be considered by a decision making process. For example, a concert that corresponds to an artist to whom a driver frequently listens may rise greatly in value as the concert date approaches. Since the concert location may be largely irrelevant (it won't change, with all likelihood, and the driver's current proximity to the location may not matter), a location value ensuring occasional or frequent delivery of the concert ad can be fixedly assigned to the ad, to ensure that the ad is delivered as appropriate.

In the example shown in FIG. 7, once ads along a route have been selected (or ads that have values designating them as displayable, regardless of “merchant location”) display distances may be set for each ad 709. That is, each ad can be assigned proximity values under which the ad should be displayed, if an ad break occurs (or is forced) while the vehicle is within the defined proximities. Ads without local merchants could be displayed, for example, if other ads are “out of proximity” and an ad break occurs.

Additionally, since workloads may vary, values for workloads may also be set to dictate display and ad duration 711. In this manner, each ad can have a set of variables dictating when it is suitable to display. For example, display ad if proximity is close and workload is low or medium, if workload is high and proximity is very close, display short version, if proximity is far don't display ad, etc. Then, along the route, as variables shift, it can be easily determined based on known values which ad to display/output 713.

Numerous and varied means can be utilized to obtain information about a driver. Drivers may be identified, for example, by the presence of a mobile device, which may have a driver profile associated therewith. In one non-limiting example, a driver may be identified by the existence of a specific key in a vehicle. This concept is explained in more detail in co-pending and commonly assigned U.S. Patent Application Publication Number US 2011/0082625 to Miller et al., filed on Dec. 13, 2010, the contents of which are incorporated herein by reference.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An advertisement message system comprising:
a plurality of modules providing current state values, including at least a travel time value, a workload value, and an advertisement optimization value;
a processor configured to receive state values from the plurality of modules; and
an advertisement database including a plurality of advertisements, wherein
the processor is further configured to determine that ad delivery is appropriate and to select an ad with a likelihood of driver response above a certain threshold based at least in part on a currently received travel time value, workload value and advertisement optimization value, and to deliver the advertisement through a vehicle output.

2. The system of claim 1, wherein the advertisement optimization value is set to designate a more valuable or less valuable advertisement based on driver responsiveness to previous advertisement(s).

3. The system of claim 2, further including a module for augmenting an optimization value based on a detected traveling or not-traveling of a vehicle to a merchant to which an advertisement corresponds.

4. The system of claim 1, wherein the processor is further configured to select a plurality of advertisements for delivery in advance of delivery, and wherein delivering the advertisements through a vehicle output is delayed until at least one predetermined condition is met.

5. The system of claim 4, wherein the predetermined condition includes a meeting of a threshold value for at least one of a GPS location proximity value, a workload value or an optimization value.

6. The system of claim 5, wherein the predetermined condition includes a meeting of a threshold value for at least two of a GPS location proximity value, a workload value or an optimization value.

7. The system of claim 5, wherein the predetermined condition includes a meeting of a threshold value for a GPS location proximity value, a workload value and an optimization value.

8. The system of claim 1, wherein the processor is further configured to select from at least a shorter or longer version of an advertisement for delivery based at least in part on a currently received GPS location proximity value, workload value or advertisement optimization value.

9. A computer-implemented method comprising:
receiving at least a proximity value, a workload value, and an advertisement optimization value at an advertisement processing system;
examining a plurality of advertisements until an advertisement having a delivery value above a threshold value is selected, the delivery value based at least in part on a calculation made using the received proximity value, workload value, and advertisement optimization value; and
delivering the selected advertisement to a driver.

10. The method of claim 9, wherein the advertisement optimization value is set to designate a more valuable or less valuable advertisement based on driver responsiveness to a previous advertisement.

11. The method of claim 10, further including augmenting an optimization value based on a detected traveling or not-traveling of a vehicle to a merchant to which an advertisement corresponds.

12. The method of claim 9, further comprising selecting a plurality of advertisements having a delivery value above the threshold value in advance of delivery, and wherein delivering the advertisements to the driver is delayed until at least one predetermined condition is met.

13. The method of claim 12, wherein the predetermined condition includes a meeting of a threshold value for at least two of a GPS location proximity value, a workload value or an optimization value.

14. The method of claim 12, wherein the predetermined condition includes a meeting of a threshold value for a GPS location proximity value, a workload value and an optimization value.

15. The method of claim 9, further comprising selecting from at least a shorter or longer version of an advertisement for delivery based at least in part on a currently received GPS location proximity value, workload value or advertisement optimization value.

16. A computer readable storage medium storing instructions that, when executed by a processor cause the processor to perform the method comprising:
receiving at least a proximity value, a workload value, and an advertisement optimization value at an advertisement processing system;
examining a plurality of advertisements until an advertisement having a delivery value above a threshold value is selected, the delivery value based at least in part on a calculation made using the received proximity value, workload value, and advertisement optimization value; and
delivering the selected advertisement to a driver.

17. The computer readable storage medium of claim 16, wherein the advertisement optimization value is set to designate a more valuable or less valuable advertisement based on driver responsiveness to a previous advertisement.

18. The computer readable storage medium of claim 17, wherein the method further includes augmenting an optimization value based on a detected traveling or not-traveling of a vehicle to a merchant to which an advertisement corresponds.

19. The computer readable storage medium of claim 16, further comprising selecting a plurality of advertisements having a delivery value above the threshold value in advance of delivery, and wherein delivering the advertisements to the driver is delayed until at least one predetermined condition is met.

20. The computer readable storage medium of claim 19, wherein the predetermined condition includes a meeting of a threshold value for at least two of a GPS location proximity value, a workload value or an optimization value.

21. The computer readable storage medium of claim 19, wherein the predetermined condition includes a meeting of a threshold value for a GPS location proximity value, a workload value and an optimization value.

22. The computer readable storage medium of claim 16, further comprising selecting from at least a shorter or longer version of an advertisement for delivery based at least in part on a currently received GPS location proximity value, workload value or advertisement optimization value.
